(19) United States
(12) Patent Application Publication
(10) Pub. No.: US 2022/0343199 A1
(43) Pub. Date: Oct. 27, 2022

(54) PARAMETER ESTIMATION DEVICE, PARAMETER ESTIMATION METHOD, AND PARAMETER ESTIMATION PROGRAM

(71) Applicant: NIPPON TELEGRAPH AND TELEPHONE CORPORATION, Tokyo (JP)

(72) Inventors: Masahiro KOJIMA, Tokyo (JP); Takeshi KURASHIMA, Tokyo (JP); Hiroyuki TODA, Tokyo (JP)

(73) Assignee: NIPPON TELEGRAPH AND TELEPHONE CORPORATION, Tokyo (JP)

(21) Appl. No.: 17/763,629

(22) PCT Filed: Oct. 2, 2019
(86) PCT No.: PCT/JP2019/038928

§ 371 Date: Mar. 24, 2022

(51) Int. Cl. G06N 7/00; G06N 20/00

(52) U.S. Cl. CPC G06N 7/005; G06N 20/00

(57) ABSTRACT

Markov chain parameters can be accurately estimated using partially observed data. A set of states, a set of observable states, censored transition data regarding the set of observable states, and perfect transition data that is complete data on transitions between states in the set of states are received as input data. Parameters relating to transition probabilities of a predetermined Markov chain defined from the set of states and a censored Markov chain defined from the set of observable states are estimated such that an objective function including a term representing a degree of agreement of the transition probability of the predetermined Markov chain, the degree of agreement thereof indicating a degree of fit to the perfect transition data, and a term representing a degree of agreement of the transition probability of the censored Markov chain, the degree of agreement thereof indicating a degree of fit to the censored transition data, is optimized.

### TECHNICAL FIELD

The disclosed technology relates to a parameter estimation apparatus, a parameter estimation method, and a parameter estimation program.

### BACKGROUND ART

A Markov process is a versatile model capable of expressing various dynamic systems and is used for various purposes such as analysis of urban people and traffic flow and analysis of queuing at ticket sales counters.

For example, a method of estimating Markov chain parameters from only perfect transition data that is complete data on transitions between states in a set of states is shown as a conventional technique (see NPL 1).

### CITATION LIST

### Non Patent Literature

NPL 1: Patrick Billingsley. Statistical methods in Markov chains. The Annals of Mathematical Statistics, pp. 12-40, 1961.

### SUMMARY OF THE INVENTION

### Technical Problem

However, existing estimation methods have a problem that it is not possible to estimate parameters of an original Markov chain using both perfect transition data and censored transition data that is partial transition data regarding a set of observable states.

The disclosed technology has been made in view of the above points and it is an object of the disclosed technology to provide a parameter estimation apparatus, a parameter estimation method, and a parameter estimation program that can accurately estimate Markov chain parameters using partially observed data.

### Means for Solving the Problem

A first aspect of the present disclosure is a parameter estimation apparatus including an estimation unit configured to receive as input data a set of states, a set of observable states, censored transition data regarding the set of observable states, and perfect transition data that is complete data on transitions between states in the set of states and estimate parameters relating to transition probabilities of a predetermined Markov chain defined from the set of states and a censored Markov chain defined from the set of observable states such that an objective function including a term representing a degree of agreement of the transition probability of the predetermined Markov chain, the degree of agreement thereof indicating a degree of fit to the perfect transition data, and a term representing a degree of agreement of the transition probability of the censored Markov chain, the degree of agreement thereof indicating a degree of fit to the censored transition data, is optimized.

A second aspect of the present disclosure is a parameter estimation method including a computer executing a process including receiving as input data a set of states, a set of observable states, censored transition data regarding the set of observable states, and perfect transition data that is complete data on transitions between states in the set of states and estimating parameters relating to transition probabilities of a predetermined Markov chain defined from the set of states and a censored Markov chain defined from the set of observable states such that an objective function including a term representing a degree of agreement of the transition probability of the predetermined Markov chain, the degree of agreement thereof indicating a degree of fit to the perfect transition data, and a term representing a degree of agreement of the transition probability of the censored Markov chain, the degree of agreement thereof indicating a degree of fit to the censored transition data, is optimized.

A third aspect of the present disclosure is a parameter estimation program causing a computer to receive as input data a set of states, a set of observable states, censored transition data regarding the set of observable states, and perfect transition data that is complete data on transitions between states in the set of states and estimate parameters relating to transition probabilities of a predetermined Markov chain defined from the set of states and a censored Markov chain defined from the set of observable states such that an objective function including a term representing a degree of agreement of the transition probability of the predetermined Markov chain, the degree of agreement thereof indicating a degree of fit to the perfect transition data, and a term representing a degree of agreement of the transition probability of the censored Markov chain, the degree of agreement thereof indicating a degree of fit to the censored transition data, is optimized.

### Effects of the Invention

According to the disclosed technology, Markov chain parameters can be accurately estimated using partially observed data.

### BRIEF DESCRIPTION OF DRAWINGS

FIG. 1 is a diagram illustrating an example of perfect transition data.

FIG. 2 is a diagram illustrating an example of censored transition data.

FIG. 3 is a schematic diagram illustrating an image of the overall concept of a method of the present disclosure.

FIG. 4 is a block diagram illustrating a configuration of a parameter estimation apparatus of the present embodiment.

FIG. 5 is a block diagram illustrating a hardware configuration of the parameter estimation apparatus.

FIG. 6 is a flowchart showing a flow of a parameter estimation process performed by the parameter estimation apparatus.

### DESCRIPTION OF EMBODIMENTS

Hereinafter, examples of embodiments of the disclosed technology will be described with reference to the drawings. The same or equivalent components and parts are denoted by the same reference signs in each drawing. The dimensional ratios in the drawings are exaggerated for convenience of explanation and may differ from the actual ratios.

In the following, first, the background and outline of the present disclosure will be described and then principles and an optimization method according to the present disclosure will be described.

Regarding the background, matters related to the nature of the Markov process will be described. Because a transition probability and an initial state probability that are parameters of the Markov process are generally unknown, it is necessary to estimate the parameters from observation data. If ideal transition data from observation of transitions between states, that is, perfect transition data, is available, the parameters can be easily estimated based on the number of transitions between states (see Non Reference Literature 1). However, because there are unobservable states in data collected in a real environment, the data may be expressed as transition data in which observations are partially missing, that is, censored transition data. Censored transition data is partial transition data regarding a set of observable states.

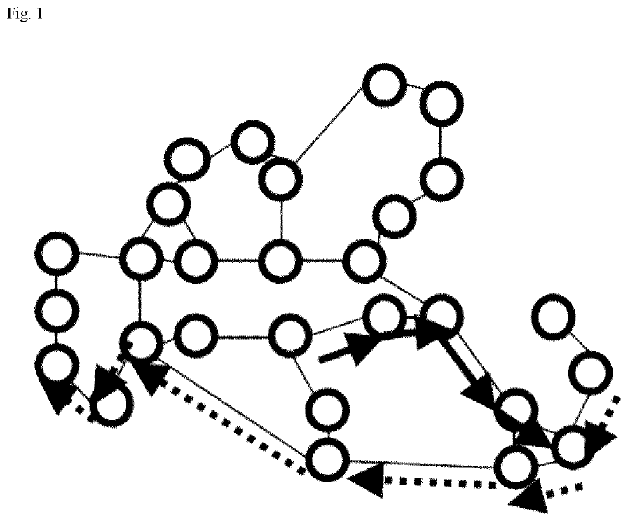

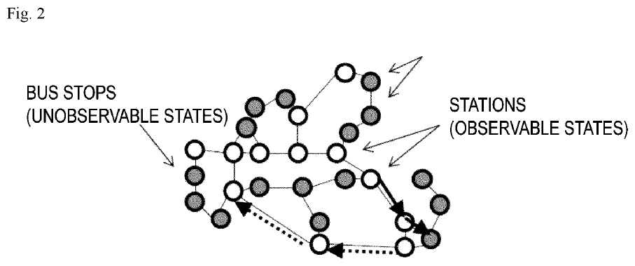

For example, the situation of analyzing the movement history data of transportation in a tourist spot will be considered. In this case, data collected by actually gathering subjects and having them move is small in amount because it is limited by the number of subjects, but is perfect transition data in which the history of movement is recorded regardless of the means of transportation such as buses, taxis, and trains. Perfect transition data is complete data on transitions between states in a set of states. FIG. 1 is a diagram illustrating an example of perfect transition data. On the other hand, data provided, for example, from a railway company in the same area is large in amount because it is data regarding all passengers so far, but only a history of movement between railway stations is known in that data. Thus, data provided by a railway company is censored transition data in which visits to states not corresponding to railway stations such as, for example, bus stops are not recorded. FIG. 2 is a diagram illustrating an example of censored transition data. A method of the present disclosure uses both the theory of a censored Markov chain and the formulation of a technique similar to semi-supervised learning to estimate Markov chain parameters from censored transition data using both types of data. This method enables more accurate parameter estimation as compared with the case where only one type of data is available. The censored Markov chain is a Markov chain defined from a set of observable states, details of which will be described later.

The existing methods are not able to estimate parameters of an original Markov chain (hereinafter referred to as a predetermined Markov chain) using both perfect transition data and censored transition data as mentioned in Technical Problem. Therefore, a technique of estimating parameters of a predetermined Markov chain using both perfect transition data and censored transition data is constructed in the method of the present disclosure. The point of the present disclosure is the use of a censored Markov chain and the formulation of semi-supervised learning. The configuration and operation of the present disclosure will be described below after the principles of a Markov chain and a censored Markov chain are described.

[Preliminary]

A set of states is represented as shown below. This will also be simply referred to as a state set X in the following description.

χ={1,2, . . . ,|χ|}

A Markov chain in discrete time on the state set X is defined as a stochastic process {Xₜ; t=0, 1, 2, . . . } having the Markov property shown in the following expression (1).

$$\begin{matrix}[ Math . 1 ] & \\ Pr ( {X}_{t + 1} = {x}_{t + 1} \vert {X}_{k} = {x}_{k} ; k = 0 , … , t ) = Pr ( {X}_{t + 1} = {x}_{t + 1} \vert {X}_{t} = {x}_{t} ) ( ∀ {x}_{k} ∈ 𝒳 , ∀ t ∈ {ℤ}_{\geq 0} ) & ( 1 )\end{matrix}$$

The Markov chain can be defined as a triad of {X, P, q}. As probabilities for the state set X, P: X×X→[0, 1] and q:X→[0, 1] are a transition probability and an initial state probability, respectively, and are defined as in the following expression (2).

### [Math. 2]

[symbol] (χₙₑₓₜ|χ) [symbol] Pr(Xₜ₊₁=χₙₑₓₜ|Xₜ=χ) and q(χ₀) [symbol] Pr(X₀=χ₀) (2)

Hereinafter, the Markov chain will be considered an irreducible Markov chain.

Further, a definition of a censored Markov chain will be given. A censored Markov chain is sometimes called a censored process, a watched Markov chain, an induced chain, or the like (see Reference 1, Reference 2, and Reference 3).
[Reference 1] John G Kemeny, J Laurie Snell, and Anthony W Knapp. Denumerable Markov chains, Vol. 40. Springer-Verlag New York, 1976.
[Reference 2] David A Levin and Yuval Peres. Markov chains and mixing times, Vol. 107. American Mathematical Soc., 2017.
[Reference 3] Y Quennel Zhao and Danielle Liu. The censored Markov chain and the best augmentation. Journal of Applied Probability, Vol. 33, No. 3, pp. 623-629, 1996.

Let O be a subset of the state set X, such that O ∈ X. O represents a set of observable states. Similarly, U represents a set of unobservable states. A censored Markov chain {Xₜ^{c}; t=0, 1, 2, . . . } is defined such that a state Xₜ^{c} at time t represents a t-th observable state appearing in the predetermined Markov chain {Xₜ^{′}; t^{′}=0, 1, 2, . . . } while ignoring unobservable states. When the times at which observable states appear in the predetermined Markov chain are denoted by σ₀, σ₁, . . . , σₜ, . . . , and so on, the censored Markov chain can be defined as follows.

Xₜ^{c}:X_{σt}

Hereinafter, the right side of this expression will also be denoted by X_{σt}. Intuitively, it can be said that the censored Markov chain is obtained by extracting only observable states from the predetermined Markov chain. The following is a strict definition of the censored Markov chain.

[Definition 1]

A sequence of points {Gt; t=0, 1, 2, . . . } representing the times at which Xₜ ∈ O is defined such that _{σ0}=0 (if X₀ ∈O), _{σ0}=inf {m≥1: Xₘ ∈O} (otherwise), and _{σt}=inf {m≥_{σt-1}: Xₘ ∈ O}. The sequence Xₜ^{c}: =X_{σt} obtained by observing Xₜ in the sequence _{σt} is called a censored Markov chain.

Thereafter, the states are rearranged without losing generality, such that a matrix representation P, (P)xx′=P(x′|x) of the transition probability of the Markov chain and a vector representation q: (q)ₓ=q(x) of the initial state probability are given by the following expression (3).

$$\begin{matrix}[ Math . 3 ] & \\ P = {\begin{matrix} \\ 𝒰\end{matrix} ( \begin{matrix}{P}_{oo} & {P}_{ou} \\ {P}_{uo} & {P}_{uu}\end{matrix} )}^{\begin{matrix} & 𝒰\end{matrix}} , q = \begin{matrix} & 𝒰 \\ ( {q}_{o} & {q}_{u} )\end{matrix} & ( 3 )\end{matrix}$$

Pₒₒ, Pₒᵤ, Pᵤₒ, and Pᵤᵤ are matrices of sizes |O|×|O|, |O|×|U|, |U|×|U|, and |U|×|U|, respectively. Results for the censored Markov chain are shown below as Theorem 1 and Theorem 2.

[Theorem 1]

The censored Markov chain is a Markov chain conforming to the following transition probability matrix.

R [symbol] Pₒₒ+Pₒᵤ(I−Pᵤᵤ)⁻¹Pᵤₒ

The following Theorem 2 is derived for the initial state probability with almost the same proof as Theorem 1 above.

[Theorem 2]

The initial state probability of the censored Markov chain is defined as s below.

s [symbol] qₒ+qᵤ(I−Pᵤᵤ)⁻¹Pᵤₒ

According to Theorems 1 and 2, the censored Markov chain created from the predetermined Markov chain {X, P, q} and the observable state set O can be defined as the triad of a Markov chain {O, R, s}.

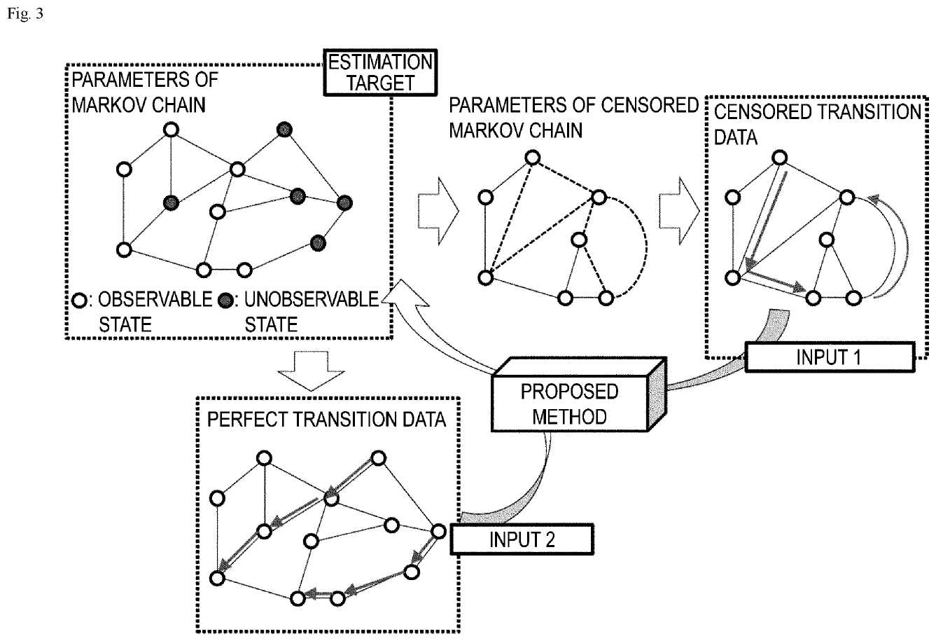

Next, an objective function and an optimization method of the present disclosure will be described based on the above principles. The method of the present disclosure is a method of estimating parameters of a predetermined Markov chain using both perfect transition data and censored transition data. FIG. 3 is a schematic diagram illustrating an image of the overall concept of the method of the present disclosure. The following are details of input data and input models (an objective function) of the present method.

The input data is (1) a set X of states of the predetermined Markov chain, (2) an observable state set O, (3) censored transition data D_{cen}, and (4) perfect transition data Dₚₑᵣ. The censored transition data D_{cen} is such that D_{cen}={Nᵢⱼ}_{ij∈O} U {Nₖⁱⁿⁱ}_{k∈O}. Nᵢⱼ is the number of transitions from an observable state i∈O to an observable state j∈O. Nₖⁱⁿⁱ represents the number of observable states k∈O that have been observed as initial states. The perfect transition data Dₚₑᵣ is such that Dₚₑᵣ={Nᵢⱼ}_{ij∈x} U {Mₖⁱⁿⁱ}k∈O. Mᵢⱼ is the number of transitions from a state j∈X to a state j∈X. Mₖⁱⁿⁱ represents the number of states k∈X that have been observed as initial states. Hereinafter, the censored transition data and the perfect transition data will be collectively expressed as D={D_{cen}, Dₚₑᵣ}.

Any models that express the transition probability and the initial states of the predetermined Markov chain can be used as the input models. The parameters of the input models included in the objective function are expressed as θ=(η, λ) and the input models of the transition probability and the initial states are expressed as P^{η} and q^{λ}. Specific examples of the objective function and input models will be shown later. The transition probability and the initial state probability of the predetermined Markov chain when this objective function is used are represented by the following expression (4).

### [Math. 4]

Pr(Xₜ₊₁=χⱼ|Xₜ=χᵢ,θ)=Pᵢⱼ^{η},Pr(X₀=χᵢ|θ)=qᵢ^{λ} (4)

As in expression (3), the states are rearranged without losing generality, such that the matrix and vector representations of the transition probability and the initial state probability using the objective function are given by the following expression (5).

### [Math. 5]

Pr(Xₜ₊₁=χⱼ|Xₜ=χᵢ,θ)=Pᵢⱼ^{η},Pr(X₀=χᵢ|θ)=qᵢ^{λ} (5)

An output of the method of the present disclosure obtained from the above input data and the input models is an estimation result θ=(η, λ) of the parameters of the objective function. The transition probability P^{η} and the initial state probability q^{λ} of the predetermined Markov chain are obtained in this manner.

Next, details of the objective function will be described. Parameter estimation in the method is performed by optimizing the objective function. Any function whose value decreases when a true distribution that generates data and a probability distribution of the model approach each other, such as Kullback-Leibler divergence (hereinafter referred to as KL divergence), can be used as the objective function. The case of using KL divergence will be considered below in the present disclosure.

It can be considered that perfect transition data, which is input data, is obtained from a predetermined Markov chain {X, P*, q*} and censored transition data is obtained from a censored Markov chain {O, R*, s*}. P* and q* are unknown true parameters of the predetermined Markov chain and R* and s* are the transition probability of a censored Markov chain created from the Markov chain {X, P*, q*} and the observable states O.

According to Theorem 1 and Theorem 2, the transition probability and the initial state probability of the censored Markov chain created from the input models P^{η} and q^{λ} and the observable states O are given by R^{η} and in the following expression (6).

### [Math. 6]

Pr(Xₜ₊₁^{c}=χⱼ|Xₜ^{c}=χᵢ,θ)=(R^{η})ᵢⱼ,R^{η} [symbol] Pₒₒ^{η}+Pₒᵤ^{η}(I−Pᵤᵤ^{η})⁻¹Pᵤₒ^{η}.

Pr(X₀^{c}=χᵢ|θ)=(s^{η,λ})ᵢ,s^{η,λ} [symbol] qₒ^{λ}+qᵤλ(I−Pᵤᵤ^{η})⁻¹Pᵤₒ^{η} (6)

It has already been shown in expression (4) that the transition probability and the initial state probability of the predetermined Markov chain are P^{η} and q^{λ}. Thus, here we will follow the formulation of semi-supervised learning. The term “follow” is used because the method of the present disclosure is similar to semi-supervised learning. Strictly speaking, semi-supervised learning refers to a setting in a problem of supervised learning that learns the relationship between input and output such as regression or discrimination, the setting being such that the relationship between input and output is learned using both data in which both input and output are given, that is, supervised data, and data in which only input is given, that is, unsupervised data. The content of the present disclosure is a setting for estimating the state transition probability, which is not that of semi-supervised learning in a strict sense. However, such a term is used here because the setting is very similar to that of semi-supervised learning in a sense that the parameters of the input models are estimated taking into consideration the degrees of fit to the two different types of data.

A linear combination of the following terms can be used as the objective function. The first term is the term of KL divergence between P^{η} and R* which represents the degree of fit to the perfect transition data. The second term is the term of KL divergence between WO′ and q*. The third term is the term of KL divergence between R^{η} and R* which represents the degree of fit to the censored transition data. The fourth term is the term of KL divergence between s^{η, λ} and s*. The fifth term is a regularization term that prevents the parameters to be estimated from diverging. Except for terms that do not depend on the parameters, the objective function can be defined by the following expressions (7-1) and (7-2).

### [Math. 7]

[symbol] (θ)=−Σ_{ij∈χ},Mᵢⱼ log(P^{η})ᵢⱼ−Σ_{k∈χ}Mₖⁱⁿⁱ log(q^{λ})ₖ (7-1)

−α_{cen}Σ_{ij∈O}Nᵢⱼ log(R^{η})ᵢⱼ−α_{cen}ⁱⁿⁱΣ_{k∈O}Nₖⁱⁿⁱ(s^{η,λ})ₖ+/βΩ(θ) (7-2)

Expression (7-1) relates to the first and second terms and expression (7-2) relates to the third to fifth terms. An objective function including the first and third terms and excluding the second and fourth terms is used when the parameter λ, of the initial state probability is not to be estimated. Here, Ω(θ) is a regularization term for the parameters and α=(α_{cen}, α_{cen}ⁱⁿⁱ) are hyperparameters that determine the degrees of contribution of the terms to the objective function. Any regularization term such as the L₂ norm may be used as the regularization term.

Next, the optimization method will be described. Any optimization method such as a gradient method or Newton's method can be applied to the optimization of the objective function. When the gradient method is used, parameter update is repeated according to the following expression (8) in a kth optimization step.

### [Math. 8]

θₖ+1←θₖ−γₖ∇θ [symbol] (θ) (8)

Where γₖ is a learning rate parameter. For the gradient ∇θL(θ) of the objective function, a function derived by computation may be used or a numerical computation method may be used.

Here, an example of the input models P^{η} and q^{λ} included in the objective function will be shown. A model of the following expression (9) having a parameter η={v^{base},v^{ftr}} is used as the model P^{η} regarding the transition probability.

$$\begin{matrix}[ Math . 9 ] & \\ {( {P}^{η} )}_{ij} = \{ \begin{matrix}exp \{ g ( i , j ; η ) \} / {\sum }_{k ∈ Ω} exp \{ g ( i , k ; η ) \} & ( j ∈ {Ω}_{i} ) \\ 0 & ( otherwise )\end{matrix} & ( 9 )\end{matrix}$$

where g(i, j, η) is a score function defined such that g(i, j, η)=vᵢⱼ^{base}+ϕ(i, j)Tᵥ^{ftr} and ϕ(i, j) is a feature vector. The feature vector ϕ(i, j) is a vector having arbitrary attribute information regarding states i and j and has, for example, elements each representing a geographical distance between the states as a vector. v^{base} is a parameter regarding the state transition and v^{ftr} is a parameter regarding the feature vector. Similarly, a model of the following expression (10) having a parameter η={w^{base}, w^{ftr}} can be considered as the model qλ regarding the initial state probability.

### [Math. 10]

(q^{λ})ᵢ=exp{h(i;λ)}/Σₖ exp{h(k;λ)}, (10)

where h(i, λ) is a score function defined such that h(i, j, λ)=wᵢ^{base}+Φ(i)Tw^{ftr} and Φ(i) is a feature vector. The feature vector Φ(i) is a vector having arbitrary attribute information regarding a state i and has, for example, elements each indicating whether or not the state is a commercial area as a vector.

The parameter estimation apparatus of the present disclosure optimizes parameters using the above objective function and optimization method.

Hereinafter, a configuration of the present embodiment will be described.

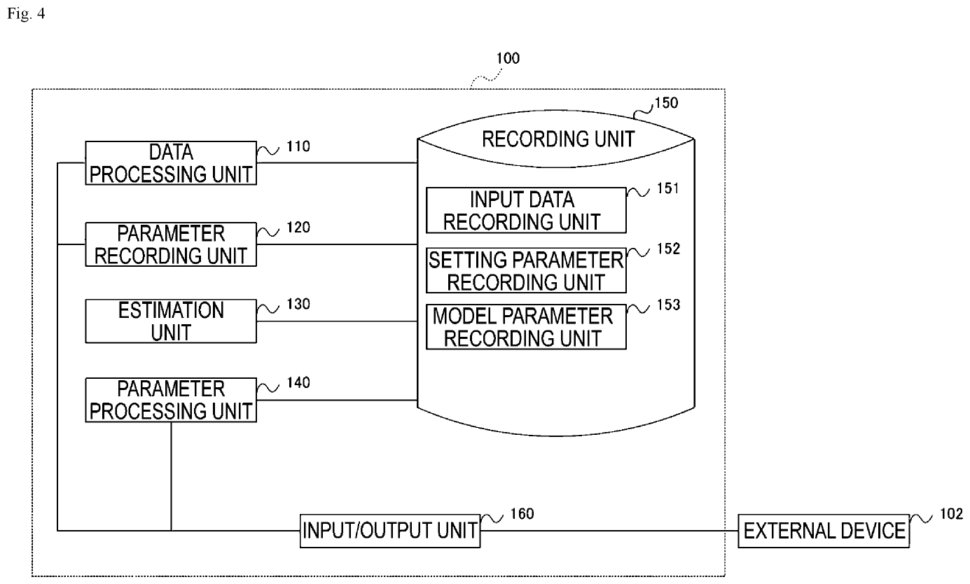

FIG. 4 is a block diagram illustrating a configuration of the parameter estimation apparatus of the present embodiment.

As illustrated in FIG. 4, the parameter estimation apparatus 100 includes a data processing unit 110, a parameter recording unit 120, an estimation unit 130, a parameter processing unit 140, a recording unit 150, and an input/output unit 160. The parameter estimation apparatus 100 is connected to an external device 102 via a network (not illustrated) and various data is transmitted and received through the input/output unit 160.

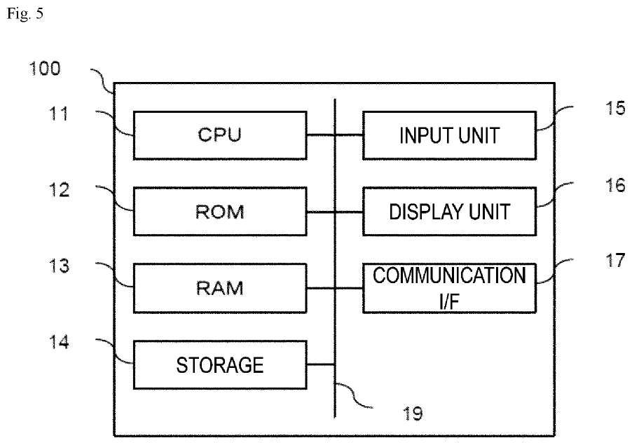

FIG. 5 is a block diagram illustrating a hardware configuration of the parameter estimation apparatus 100.

As illustrated in FIG. 5, the parameter estimation apparatus 100 includes a central processing unit (CPU) 11, a read only memory (ROM) 12, a random access memory (RAM) 13, a storage 14, an input unit 15, a display unit 16, and a communication interface (I/F) 17. These components are communicatively connected to each other via a bus 19.

The CPU 11 is a central arithmetic processing unit and executes various programs and controls each part. That is, the CPU 11 reads a program from the ROM 12 or the storage 14 and executes the program using the RAM 13 as a work area. The CPU 11 controls each of the components described above and performs various arithmetic processing according to programs stored in the ROM 12 or the storage 14. In the present embodiment, the ROM 12 or the storage 14 stores a parameter estimation program.

The ROM 12 stores various programs and various data. The RAM 13 is a work area that temporarily stores a program or data. The storage 14 includes a storage device such as a hard disk drive (HDD) or a solid state drive (SSD) and stores various programs including an operating system and various data.

The input unit 15 includes a pointing device such as a mouse and a keyboard and is used to perform various inputs.

The display unit 16 is, for example, a liquid crystal display and displays various types of information. The display unit 16 may adopt a touch panel method and function as an input unit 15.

The communication interface 17 is an interface for communicating with other devices such as a terminal and uses standards such as, for example, Ethernet (registered trademark), FDDI, and Wi-Fi (registered trademark).

Next, each functional component of the parameter estimation apparatus 100 will be described. Each functional component is realized by the CPU 11 reading the parameter estimation program stored in the ROM 12 or the storage 14 and loading and executing the parameter estimation program into and from the RAM 13.

The input/output unit 160 receives input data and setting parameters of the objective function from the external device 102.

The data processing unit 110 records the input data received by the input/output unit 160 in an input data recording unit 151 in the recording unit 150. The input data is a state set X, an observable state set O, censored transition data D_{cen}, and perfect transition data Dₚₑᵣ.

The parameter recording unit 120 records the setting parameters received by the input/output unit 160 in a setting parameter recording unit 152 in the recording unit 150. The setting parameters are hyperparameters a and 13 of the objective function and a learning rate parameter λₖ used for optimization.

The estimation unit 130 reads the input data recorded in the input data recording unit 151 and the setting parameters recorded in the setting parameter recording unit 152, executes a parameter estimation process, and records estimated parameters θ=(η, λ) in a model parameter recording unit 153.

As a process, the estimation unit 130 estimates the parameters θ=(η, λ) such that the objective function represented by the above expressions (7-1) and (7-2) is optimized. η is a parameter relating to the respective transition probabilities P^{η} and R^{η} of the predetermined Markov chain and the censored Markov chain. λ is a parameter relating to the respective initial state probabilities q^{η, λ} and s^{η, λ} of the predetermined Markov chain and the censored Markov chain. In the optimization method for estimation, a process of estimating the parameters θaccording to the above expression (8) is repeated until a predetermined condition is satisfied. For example, the maximum number of repetitions is set as a predetermined condition.

The parameter processing unit 140 transmits the parameters θrecorded in the model parameter recording unit 153 to the external device 102 through the input/output unit 160.

Next, an operation of the parameter estimation apparatus 100 will be described.

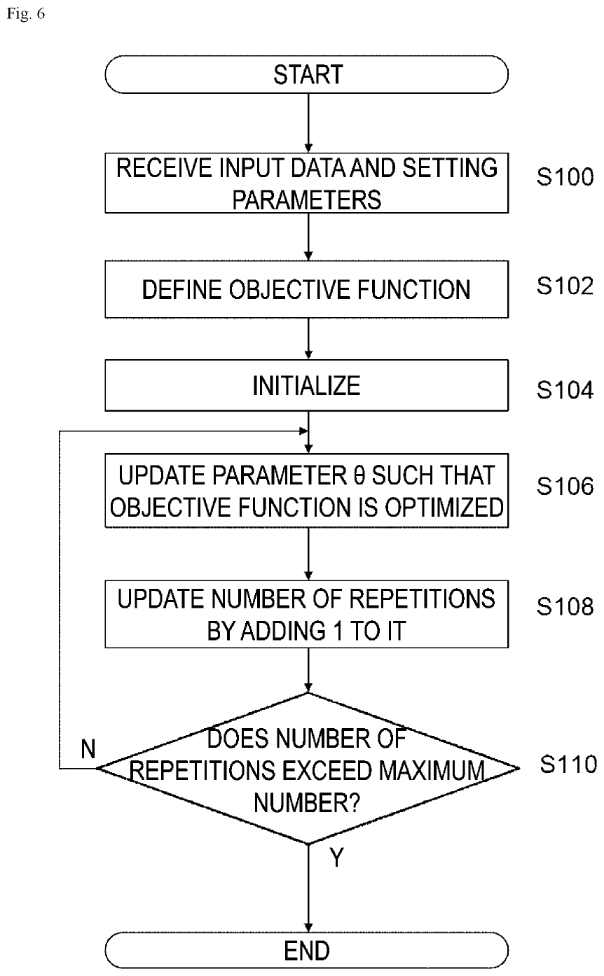

FIG. 6 is a flowchart showing the flow of a parameter estimation process performed by the parameter estimation apparatus 100. The parameter estimation process is performed by the CPU 11 reading the parameter estimation program from the ROM 12 or the storage 14 and loading and executing the parameter estimation program into and from the RAM 13.

In step S100, the CPU 11 receives the input data and the setting parameters as inputs and records them in the respective recording units of the recording unit 150 as described above. The CPU 11 receives a state set X, an observable state set O, censored transition data D_{cen}, and perfect transition data Dₚₑᵣ as input data and records them in the input data recording unit 151. The CPU 11 receives hyperparameters a and 13 of an objective function, a learning rate parameter γₖ used for optimization, and the like as setting data and records them in the setting parameter recording unit 152.

In step S102, the CPU 11 reads the input data from the input data recording unit 151, reads the setting parameters from the setting parameter recording unit 152, and defines an objective function, for example, as shown in expressions (7-1) and (7-2).

In step S104, the CPU 11 initializes the parameters θ, sets the number of repetitions k such that k=0, and sets the maximum number of repetitions K.

In step S106, the CPU 11 updates and estimates the parameters θ according to the above expression (8) such that the objective function defined in step S102 is optimized.

In step S108, the CPU 11 updates the number of repetitions k by adding 1 to the number of repetitions k.

In step S110, the CPU 11 determines whether or not the number of repetitions k exceeds the maximum number K. If the number of repetitions k exceeds the maximum number K, the CPU 11 records the estimation result of the parameters θ in the model parameter recording unit 153 and ends the process. If the number of repetitions k does not exceed the maximum number K, the CPU 11 returns to step S106 and repeats the process.

The parameter estimation apparatus 100 of the present embodiment can accurately estimate parameters of the Markov chain using partially observed data as described above.

Although the above embodiment shows an example in which the gradient method is used for optimization, any method such as Newton's method can be used. Similarly, any models can be used as those for the state transition probability and the initial state probability. Similarly, any regularization term can be used as that of the objective function. Further, the parameter estimation apparatus illustrated in FIG. 4 of the above embodiment may be implemented such that the operation of each component is constructed as a program and then installed on and executed by a computer used as the parameter estimation apparatus or distributed via a network. The present disclosure is not limited to the above embodiments and various modifications and applications are possible.

The parameter estimation process executed by the CPU reading software (program) in the above embodiment may also be executed by various processors other than the CPU. Examples of such processors include a programmable logic device (PLD) whose circuit configuration can be changed after manufacturing such as a field-programmable gate array (FPGA) and a dedicated electric circuit which is a processor having a circuit configuration specially designed to execute specific processing such as an application specific integrated circuit (ASIC). The parameter estimation process may be executed by one of these various processors or may be executed by a combination of two or more processors of the same type or different types (such as, for example, a plurality of FPGAs or a combination of a CPU and an FPGA). A hardware structure of these various processors is, more specifically, an electric circuit that combines circuit elements such as semiconductor elements.

The above embodiments have been described with reference to a mode in which the parameter estimation program is stored (installed) in the storage 14 in advance. However, the present disclosure is not limited to this. Programs may be provided in a form stored in a non-transitory storage medium such as a compact disc read only memory (CD-ROM), a digital versatile disc ROM (DVD-ROM), or a universal serial bus (USB) memory. Programs may also be in a form downloaded from an external device via a network.

Regarding the above embodiments, the following supplements are further disclosed.

Supplement 1

A parameter estimation apparatus including:
a memory; and
at least one processor connected to the memory,
wherein the processor is configured to receive as input data a set of states, a set of observable states, censored transition data regarding the set of observable states, and perfect transition data that is complete data on transitions between states in the set of states and estimate parameters relating to transition probabilities of a predetermined Markov chain defined from the set of states and a censored Markov chain defined from the set of observable states such that an objective function including a term representing a degree of agreement of the transition probability of the predetermined Markov chain, the degree of agreement thereof indicating a degree of fit to the perfect transition data, and a term representing a degree of agreement of the transition probability of the censored Markov chain, the degree of agreement thereof indicating a degree of fit to the censored transition data, is optimized.

Supplement 2

A non-transitory storage medium storing a parameter estimation program causing a computer to receive as input data a set of states, a set of observable states, censored transition data regarding the set of observable states, and perfect transition data that is complete data on transitions between states in the set of states and estimate parameters relating to transition probabilities of a predetermined Markov chain defined from the set of states and a censored Markov chain defined from the set of observable states such that an objective function including a term representing a degree of agreement of the transition probability of the predetermined Markov chain, the degree of agreement thereof indicating a degree of fit to the perfect transition data, and a term representing a degree of agreement of the transition probability of the censored Markov chain, the degree of agreement thereof indicating a degree of fit to the censored transition data, is optimized.

### REFERENCE SIGNS LIST

100 Parameter estimation apparatus
102 External device
110 Data processing unit
120 Parameter recording unit
130 Estimation unit
140 Parameter processing unit
150 Recording unit
151 Input data recording unit
152 Setting parameter recording unit
153 Model parameter recording unit
160 Input/output unit

1. A parameter estimation apparatus comprising a circuit configured to execute a method comprising:
receiving, as input data:
a set of states,
a set of observable states,
censored transition data regarding the set of observable states, and
perfect transition data that is complete data on transitions between states in the set of states; and
estimating parameters relating to transition probabilities of a predetermined Markov chain defined from the set of states and a censored Markov chain defined from the set of observable states, by optimizing an objective function including a term representing a degree of agreement of the transition probability of the predetermined Markov chain,
wherein the degree of agreement thereof indicates a degree of fit to the perfect transition data,
wherein a term represents a degree of agreement of the transition probability of the censored Markov chain, and
wherein the degree of agreement thereof indicates a degree of fit to the censored transition data.

2. The parameter estimation apparatus according to claim 1, wherein the objective function further includes:
a term representing a degree of agreement of an initial state probability of the predetermined Markov chain,
a term representing a degree of agreement of an initial state probability of the censored Markov chain, and
a normalization term that prevents the parameters from diverging, and
the circuit further configured to execute a method comprising:
estimating a parameter relating to the transition probabilities and a parameter relating to the initial state probability of the predetermined Markov chain and the censored Markov chain such that the objective function is optimized.

3. The parameter estimation apparatus according to claim 1, wherein the objective function is based on Kullback-Leibler divergence,
wherein the term representing the degree of agreement of the transition probability of the predetermined Markov chain uses a number of transitions between states of the perfect transition data, and
wherein the number of transitions between observable states of the censored transition data is used for the term representing the degree of agreement of the transition probability of the censored Markov chain.

4. A computer-implemented method for estimating parameters, the method comprising:
receiving as input data:
a set of states,
a set of observable states,
censored transition data regarding the set of observable states, and
perfect transition data that is complete data on transitions between states in the set of states; and
estimating parameters relating to transition probabilities of a predetermined Markov chain defined from the set of states and a censored Markov chain defined from the set of observable states, by optimizing an objective function including a term representing a degree of agreement of the transition probability of the predetermined Markov chain,
wherein the degree of agreement thereof indicates a degree of fit to the perfect transition data,
wherein the term represents a degree of agreement of the transition probability of the censored Markov chain, and
wherein the degree of agreement thereof indicates a degree of fit to the censored transition data.

5. The computer-implemented method according to claim 4, wherein the objective function further includes:
a term representing a degree of agreement of an initial state probability of the predetermined Markov chain,
a term representing a degree of agreement of an initial state probability of the censored Markov chain, and
a normalization term that prevents the parameters from diverging, and
the method further comprising:
estimating a parameter relating to the transition probabilities and a parameter relating to the initial state probability of the predetermined Markov chain and the censored Markov chain such that the objective function is optimized.

6. The computer-implemented method according to claim 4, wherein the objective function is based on Kullback-Leibler divergence,
wherein the term representing the degree of agreement of the transition probability of the predetermined Markov chain uses a number of transitions between states of the perfect transition data, and
wherein the number of transitions between observable states of the censored transition data is used for the term representing the degree of agreement of the transition probability of the censored Markov chain.

7. A computer-readable non-transitory recording medium storing computer-executable program instructions that when executed by a processor cause a computer system to execute a method comprising:
receiving as input data:
a set of states,
a set of observable states,
censored transition data regarding the set of observable states, and
perfect transition data that is complete data on transitions between states in the set of states; and
estimating parameters relating to transition probabilities of a predetermined Markov chain defined from the set of states and a censored Markov chain defined from the set of observable states such that an objective function including a term representing a degree of agreement of the transition probability of the predetermined Markov chain,
wherein the degree of agreement thereof indicating a degree of fit to the perfect transition data,
wherein a term representing a degree of agreement of the transition probability of the censored Markov chain, and
wherein the degree of agreement thereof indicating a degree of fit to the censored transition data, is optimized.

8. The parameter estimation apparatus according to claim 1,
wherein the censored transition data includes data associated with movement of people at a railway station, and
wherein the perfect transition data includes data associated with movement of people at a combination of the railway station associated with a train as a means of transportation and another location associated with another means of transportation.

9. The parameter estimation apparatus according to claim 2, wherein the objective function is based on Kullback-Leibler divergence,
wherein the term representing the degree of agreement of the transition probability of the predetermined Markov chain uses a number of transitions between states of the perfect transition data, and
wherein the number of transitions between observable states of the censored transition data is used for the term representing the degree of agreement of the transition probability of the censored Markov chain.

10. The computer-implemented method according to claim 4,
wherein the censored transition data includes data associated with movement of people at a railway station, and
wherein the perfect transition data includes data associated with movement of people at a combination of the railway station associated with a train as a means of transportation and another location associated with another means of transportation.

11. The computer-implemented method according to claim 5, wherein the objective function is based on Kullback-Leibler divergence,
wherein the term representing the degree of agreement of the transition probability of the predetermined Markov chain uses a number of transitions between states of the perfect transition data, and
wherein the number of transitions between observable states of the censored transition data is used for the term representing the degree of agreement of the transition probability of the censored Markov chain.

12. The computer-readable non-transitory recording medium according to claim 7, wherein the objective function further includes:
a term representing a degree of agreement of an initial state probability of the predetermined Markov chain,
a term representing a degree of agreement of an initial state probability of the censored Markov chain, and
a normalization term that prevents the parameters from diverging, and
the computer-executable program instructions when executed further cause the computer system to execute a method comprising:
estimating a parameter relating to the transition probabilities and a parameter relating to the initial state probability of the predetermined Markov chain and the censored Markov chain such that the objective function is optimized.

13. The computer-readable non-transitory recording medium according to claim 7, wherein the objective function is based on Kullback-Leibler divergence,
wherein the term representing the degree of agreement of the transition probability of the predetermined Markov chain uses a number of transitions between states of the perfect transition data, and
wherein the number of transitions between observable states of the censored transition data is used for the term representing the degree of agreement of the transition probability of the censored Markov chain.

14. The computer-readable non-transitory recording medium according to claim 7,
wherein the censored transition data includes data associated with movement of people at a railway station, and
wherein the perfect transition data includes data associated with movement of people at a combination of the railway station associated with a train as a means of transportation and another location associated with another means of transportation.

15. The computer-readable non-transitory recording medium according to claim 12,
wherein the term representing the degree of agreement of the transition probability of the predetermined Markov chain uses a number of transitions between states of the perfect transition data, and
wherein the number of transitions between observable states of the censored transition data is used for the term representing the degree of agreement of the transition probability of the censored Markov chain.
